(19) United States
(12) Patent Application Publication
(10) Pub. No.: US 2025/0390548 A1
(43) Pub. Date: Dec. 25, 2025

(54) Systems and Methods for Solving Computational Problems Using High-Performance Computing

(71) Applicant: REGENTS OF THE UNIVERSITY OF MICHIGAN, Ann Arbor, MI (US)

(72) Inventors: Venkatasubramanian Viswanathan, Ann Arbor, MI (US); Shang Zhu, San Francisco, CA (US); Karthik Duraisamy, Ann Arbor, MI (US)

(21) Appl. No.: 19/237,576

(22) Filed: Jun. 13, 2025

Related U.S. Application Data
(60) Provisional application No. 63/663,673, filed on Jun. 24, 2024.

(51) Int. Cl. G06F 17/11; G06F 8/30

(52) U.S. Cl. CPC G06F 17/11; G06F 8/30

(57) ABSTRACT

Systems and methods for solving computational problems using high-performance computing (HPC) are described herein. An example system receives a request from a computing device indicating a computational problem. The example system applies a supervisor model to the computational problem to generate (i) a workflow and (ii) a set of code, and an HPC agent of the example system determines a respective HPC environment satisfying computing resource requirements of the set of code. A computing agent of the example system executes the set of code within the respective HPC environment to generate an output associated with solving the computational problem, wherein the HPC agent controls execution of the set of code by the computing agent according to the workflow. The example system also applies the supervisor model to the output to generate a solution to the computational problem and provide the solution to a computing device.

### CROSS-REFERENCE TO RELATED APPLICATIONS

The present disclosure claims priority to U.S. Provisional Application Ser. No. 63/663,673 filed Jun. 24, 2024, the entire contents of which is hereby incorporated by reference.

### TECHNICAL FIELD

The present disclosure generally relates to solving computational problems, and more particularly, to systems and methods for solving computational problems using high-performance computing.

### BACKGROUND

In the realm of computational science, the use of foundation models, particularly those based on transformer technologies, has been a notable advancement for handling structured computational and experimental data. Despite these advancements, a significant volume of unstructured computational and experimental data, along with metadata such as workflows, scripts, and log files, remains largely untapped or underutilized due to challenges associated with processing and integrating unstructured data into computational models.

Furthermore, the iterative process of hypothesis creation and evaluation in computational sciences relies heavily on high-fidelity simulation codes and workflows. The complexity of solving computational problems in high-performance computing (HPC) environments (e.g., exascale computing) introduces additional challenges such as the need for sophisticated code generation, workflow design, and the effective utilization of HPC resources. The ability to incorporate multi-fidelity simulations and to interact seamlessly with various domain-specific models and computational resources is essential for enhancing productivity and optimizing the value derived from computational and experimental data.

Conventional computational problem solving suffers from additional defects and detriments.

### SUMMARY

The present embodiments relate to systems and methods for solving computational problems using high-performance computing.

In one embodiment, a system may include (i) one or more processors; (ii) one or more memories; (iii) a supervisor model, stored on the one or more memories, trained using model training data to provide respective solutions to computational problems, including generating (a) workflows and (b) code for solving the computational problems; (iv) a high-performance computing (HPC) agent stored on the one or more memories and configured to determine one or more HPC environments for executing the code according to the workflows; (v) a computing agent stored on the one or more memories and configured to execute the code in the one or more HPC environments; and the one or more memories storing instructions that, when executed by the one or more processors, may cause the system to: (i) receive, from a computing device, a request indicating a computational problem, (ii) apply the supervisor model to the computational problem to generate (a) a workflow and (b) a set of code, (iii) determine, by the HPC agent, a respective HPC environment of the one or more HPC environments satisfying computing resource requirements of the set of code, (iv) execute, by the computing agent, the set of code within the respective HPC environment to generate an output associated with solving the computational problem, wherein the HPC agent controls execution of the set of code by the computing agent according to the workflow, (v) apply the supervisor model to the output to generate a solution to the computational problem, and (vi) provide, to the computing device, the solution.

In a variation of the embodiment, the system may include a plurality of domain-specific models stored on the one or more memories trained using respective domain-specific training data to provide solutions to respective domain-specific computational problems; and the instructions, when executed by the one or more processors, further cause the system to: determine a domain associated with the computational problem, and select, based upon the domain, a domain-specific model of the plurality of domain-specific models, wherein the model includes the domain-specific model.

In another variation of the embodiment, one or more of the plurality of domain-specific models are multi-modal models.

In yet another variation of the embodiment, the domain is selected from a group consisting of: physics, chemistry, biology, density functional theory, engineering, neuroscience, combustion, astrophysics, and materials science.

In a still yet variation of the embodiment, the model includes a large language model (LLM).

In a variation of the embodiment, the LLM is a pre-trained LLM fine-tuned using computational science training data to generate and/or understand computational science concepts.

In another variation of the embodiment, the model training data includes one or more of: computational simulation data, computational workflows, computational code, multi-modal computational data, multi-fidelity computational data, or computational experimental data.

In yet another variation of the embodiment, one or more of: the HPC environment includes an exascale computer; or the computing resource requirements include one or more of: processor requirements, memory requirements, code compatibility, or node characteristic

In still yet another variation of the embodiment, at least a portion of the one or more memories stores data associated with solving the computational problem and is accessible to one or more of the supervisor model, the HPC agent, the computing agent, or the plurality of domain-specific models.

In a variation of the embodiment, the computing agent is further configured to one or more of: test the code, troubleshoot the code, generate new code, or optimize the code for a specific HPC environment.

In another variation of the embodiment, the request is a prompt.

In yet another variation of the embodiment, the system may include a validation agent stored on the one or more memories and configured to validate the output of the code; and instructions that, when executed by the one or more processors, cause the system to validate, by a validation agent configured to validate the output of the code, the code; and perform, by the validation agent, a corrective action responsive to the output failing validation.

In still yet another variation of the embodiment, the corrective action includes one or more of re-executing the code, debugging the code, or selecting a different HPC environment.

In a variation of the embodiment, the system may determine a fidelity of the solution to the computational problem; and responsive to the fidelity not exceeding threshold fidelity, generating an alternate workflow and/or alternate code to solve the computational problem.

In another variation of the embodiment, the system may obtain HPC information indicating computing resources of the one or more HPC environments, wherein to determine, by the HPC agent, the respective HPC environment satisfying computing resource requirements of the set of code is based at least in part upon the HPC information.

In yet another variation of the embodiment, the computing resources include one or more of: processor characteristics, memory characteristics, bandwidth, size, availability, or cost.

In another embodiment, a method may include (i) receiving, by one or more processors from a computing device, a request indicating a computational problem; (ii) applying, by the one or more processors, a supervisor model trained using model training data to the computational problem to generate (a) a workflow and (b) a set of code; (iii) determining, by a high-performance computing (HPC) agent configured to determine one or more HPC environments for executing code according to workflows, a respective HPC environment of one or more HPC environments satisfying computing resource requirements of the set of code; (iv) executing, by a computing agent configured to execute the code in the one or more HPC environments, the set of code within the respective HPC environment to generate an output associated with solving the computational problem, wherein the HPC agent controls execution of the set of code by the computing agent according to the workflow; (v) applying, by the one or more processors, the supervisor model to the output to generate a solution to the computational problem; and (vi) providing, by the one or more processors to the computing device, the solution.

In yet another embodiment, a tangible machine-readable medium comprising instructions that, when executed by one or more processors, may cause a machine to at least: (i) receive from a computing device, a request indicating a computational problem; (ii) apply a supervisor model trained using model training data to the computational problem to generate (a) a workflow and (b) a set of code; (iii) determine, by a high-performance computing (HPC) agent configured to determine one or more HPC environments for executing code according to workflows, a respective HPC environment of one or more HPC environments satisfying computing resource requirements of the set of code; (iv) execute, by a computing agent configured to execute the code in the one or more HPC environments, the set of code within the respective HPC environment to generate an output associated with solving the computational problem, wherein the HPC agent controls execution of the set of code by the computing agent according to the workflow; (v) apply, by the one or more processors, the supervisor model to the output to generate a solution to the computational problem; and (vi) provide, by the one or more processors to the computing device, the solution.

### BRIEF DESCRIPTION OF THE DRAWINGS

The Figures described below depict preferred embodiments for purposes of illustration only. One skilled in the art will readily recognize from the following discussion that alternative embodiments of the systems and methods illustrated herein may be employed without departing from the principles of the disclosure described herein.

FIG. 1 depicts a block diagram of an example computing environment in which methods and systems for solving computational problems using high-performance computing are implemented, according to some embodiments.

FIG. 2 depicts a flow diagram for example ML model training and operation, according to some embodiments.

FIG. 3A depicts a block diagram of an example high-level workflow 300 for solving a computation materials science problem, according to some embodiments.

FIG. 3B depicts an example flowchart 340 for performing the lattice workflow tasks associated with calculating a lattice constant, according to some embodiments.

FIG. 3C depicts an example workflow for solving an example surface energy computational problem, according to some embodiments.

FIG. 4 depicts an example method for solving an example surface energy computational problem, according to some embodiments.

### DETAILED DESCRIPTION

The present techniques introduce a sophisticated framework designed to enhance the efficiency and effectiveness of solving computational problems through the integration of a machine learning model, a high-performance computing (HPC) agent, and a computing agent. This framework is adept at generating workflows and code tailored to address specific computational challenges, thereby streamlining the process from problem identification to solution delivery. The model is trained on a diverse set of model training data, enabling it to provide precise solutions to a wide range of computational problems. This capability is further enriched by the inclusion of domain-specific models, which are trained on respective domain-specific training data, allowing for specialized problem-solving across various scientific domains.

One of the improvements provided by the present techniques includes leveraging a model trained to generate both workflows and code, to automatically develop a framework for solving the computational problem. Additionally, an HPC agent is configured to identify the most suitable HPC environment for executing the generated code according to the workflows. This intelligent matching process ensures that the code is executed in an HPC environment that meets the specific computing resource requirements of the code and/or workflow, minimizing unnecessary network traffic and optimizing the use of the HPC resources.

Further, the present techniques include a computing agent to execute the code in the HPC environment at the direction of the HPC agent according to the workflow. In some embodiments, the computing agent is capable of testing, troubleshooting, generating new code, and optimizing the code for specific HPC environments. Such capabilities ensure that the code execution is not only efficient but also adaptable to the nuances of different HPC environments, further contributing to the system's overall effectiveness.

Moreover, the system's design may include a validation agent responsible for ensuring the accuracy and reliability of the code's output. The validation agent performs validation checks and takes corrective action if necessary, thereby ensuring that the solutions provided are of high fidelity and meet the computational problem's requirements.

The present techniques offer a comprehensive and integrated approach to solving computational problems, marked by significant improvements in processing efficiency. Through the use of a trained model and optimized resource allocation, the system improves computational problem-solving in various scientific domains.

Accordingly, the techniques of the present disclosure improve the functionality of a computing device (e.g., a hosting server) at least by analyzing data in a particular way to enhance the accuracy and efficiency of the computing device. The combination of the model, the HPC agent, and the computing agent executing on the computing device generate solutions to computational problems with an accuracy and efficiency not achieved using conventional techniques. The specific model is trained using specific training data to be able to analyze a computational problem of a request, and based upon the analysis the model both generates a workflow of steps that lead to a solution of the problem, and generates associated code that when executed in correspondence with the workflow by the HPC agent and computing agent, provides one or more outputs associated with solving the computational problem. The HPC agent and computing agent are particularly configured to perform in conjunction with one another to execute the code according to the workflow in an HPC environment capable of solving the computational problem. That is, the present disclosure describes improvements in the functioning of the computer itself because the computing device is particularly configured to provide specific capabilities for solving computational problems that conventional and generic prior art systems are otherwise unable to solve as a direct results of the particularly trained and/or configured model, HPC agent, and computing agent operating in tandem to individually perform a multitude of steps that collectively provide a solution to a computational problem with heretofore unrealized and/or unmatched accuracy and efficiency.

The present disclosure includes specific features other than what is well-understood, routine, conventional activity in the field, and/or otherwise adds unconventional steps that confine the disclosure to a particular useful application, e.g., receive, from a computing device, a request indicating a computational problem; apply the model to the computational problem to generate (i) a workflow and (ii) a set of code; determine, by the HPC agent, a respective HPC environment of the one or more HPC environments satisfying computing resource requirements of the set of code; execute, by the computing agent, the set of code within the respective HPC environment to generate an output associated with solving the computational problem, wherein the HPC agent controls execution of the set of code by the computing agent according to the workflow; and/or apply the model to the output to generate a solution to the computational problem; and provide, to the computing device, the solution, among others. The technical improvements and advantages described herein are not the sole improvements and advantages, and other improvements and advantages may be apparent to one of ordinary skill in the art.

As used herein, the terms “model”, “machine learning model”, “agent”, and the like may be used interchangeably at times.

### Computing Environment

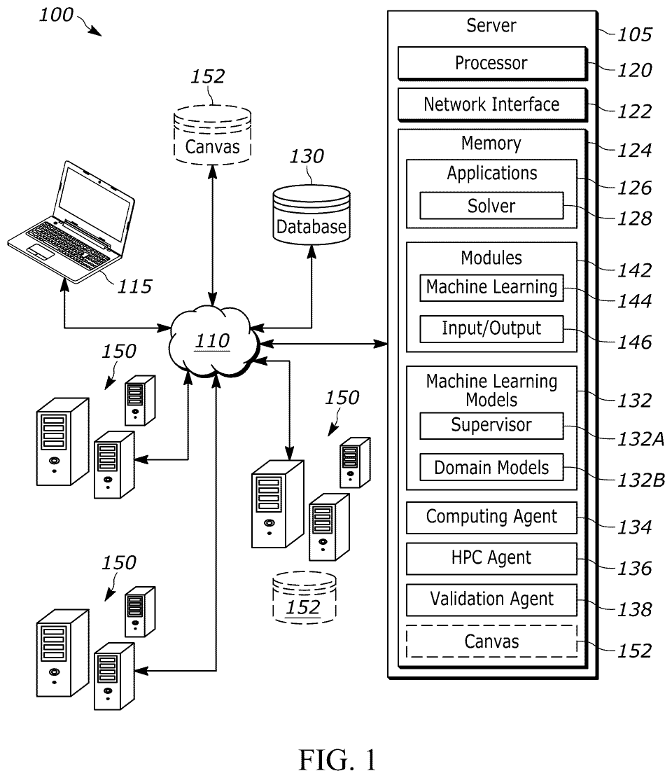

FIG. 1 depicts an example computing environment 100 for solving computation problems, according to an embodiment. The computing environment 100 includes a server 105, a computing device 115, an external database 130, and HPC environments 150, all of which are communicatively connected by the network 110. Although FIG. 1 depicts certain entities, components, equipment, and devices, it should be appreciated that additional or alternate entities, components, equipment, and devices are also possible.

In the example embodiment of FIG. 1, the server 105 includes a processor 120, a network interface 122, and a memory 124. In certain embodiments, the server 105 may be a centralized computing resource configured to execute exascale-level computing tasks, as received from a user (e.g., via the computing device 115). To execute such tasks, the server 105 utilizes various applications 126, modules 142, ML models 132, computing agents 134, HPC agents 136, and/or validation agents 138 stored in memory 124.

For example, the applications 126 include a solver application 128. The solver application 128 may provide various functionalities described in further detail below, such as receiving computational problems, providing computation problem solutions, displaying code and/or workflows associated with solving computational problems, and the like. In at least some embodiments, the solver application 128 may include, use, and/or be communicatively coupled to, one or more models and/or agents.

The server 105 may include, and/or have access to (e.g., via network 110), at least one database 130. The database 130 may include one or more databases that are co-located or remotely distributed. The database 130 may be or include a relational database, such as Oracle, DB2, MySQL, a NoSQL based database, such as MongoDB, or another suitable database. The database 130 may store data and/or datasets discussed herein, such as models, training data used to train and/or operate one or more models, and so on. A dataset may include one or more types of data, records, files, etc. The terms “data” and “dataset” may be used interchangeably herein.

The memory 124 may store one or more models 132, discussed briefly here and in more detail below. The models 132 may be referred to at times herein as “models,” “machine learning models,” “agents,” and/or “algorithms.”

In some embodiments, a supervisor model 132A (e.g., a machine learning model) may be trained to provide solutions to computational problems, and/or interact with agents to provide solutions to computational problems. The supervisor model 132A may generate a workflow to solve a respective computational problem, and/or generate a set of code to solve a respective computational problem.

The models 132 may include a plurality of domain-specific models 132B to provide solutions to respective domain-specific computational problems. The domains may include physics, chemistry, biology, density functional theory, engineering, neuroscience, combustion, astrophysics, materials science, and/or any other suitable domain, such as computation science domains.

At least some of the models 132 may be generative models (e.g. the models generating code and workflows to solve computational problems). Generally speaking, a generative model may be trained to receive input data, and generate as an output new content that is reflective of the input. In some embodiments, the generative model includes a large language model (LLM).

The memory 124 may store one or more agents to perform tasks, gather information, provide services, and the like, associated with solving a computational problem. One or more of the agents may interact with, and/or include, one or more of the models 132.

The memory 124 may store a computing agent 134 configured to execute code (e.g., code generated by a generative model to solve a computational problem) in the HPC environment 150, test the code, troubleshoot the code, generate new code, and/or optimize the code for a specific HPC environment 150.

The memory 124 may store an HPC agent 136 configured to determine one or more HPC environments 150 for executing the code (e.g., via the computing agent 134) according to a workflow (e.g., a workflow generated by the supervisor model 132A).

The memory 124 may store a validation agent 138 configured to validate the output of the code (e.g., the output of code for solving the computational problem). In response to the output failing validation, the validation agent 138 may perform one or more corrective actions, such as re-executing the code, debugging the code, selecting a different HPC environment 150 to execute the code, and/or any other suitable corrective action.

The computing environment 100 also includes one or more HPC environments 150, for example HPC environments 150 to execute code associated with solving the computation problem. Each HPC environment 150 may include several components working together to perform large-scale computations, such as a plurality of nodes each including processors, such as CPUs, GPUs, high-performance processors (e.g., AMD EPYC, Intel Xeon, or NVIDIA GPUs); large amounts of memory (e.g., random-access memory); high-speed storage solutions (e.g., nonvolatile memory express, solid-state drives, SSDs, distributed storage systems, and parallel file systems), high-speed interconnects (e.g., InfiniBand, Omni-Path, high-speed Ethernet) for fast data transfer between nodes, and a network interface (e.g., the network interface 122), among other things. Each of the HPC environments 150 may have different computing resources such as processor characteristics, memory characteristics, bandwidth, size, availability, cost, and/or other suitable computing resources. In at least some embodiments, the HPC environments 150 include an exascale computer.

At least a portion of one or more memories (e.g., the memory 124) and/or storage components (e.g., of the database 130, the HPC environment 150) may include a canvas 152. The canvas 152 may store information associated with solving the computational problem that is shared with one or more models, agents, components, and/or devices of the computing environment 100). The canvas 152 may provide one or more of lossless and/or time-invariant data sharing, store variables in a native format (e.g. for reducing errors and preventing hallucinations associated with data conversion). For example, before performing a task, one or more of the models 132, the computing agent 134, the HPC agent 136, and/or the validation agent 138 may access the canvas to retrieve data and/or store data after performing a task. The canvas 152 may provide one or more functions associated with inspection, reading, and/or writing of data, for example by storing data in a centralized dictionary object. For inspection, no arguments may be required for canvas 152 to provide a list of all available keys. For reading, a key may be used for the canvas 152 to return a corresponding value. If the key is invalid, the canvas 152 may suggests performing an inspection to locate the correct key before attempting to read again. For writing, a descriptive key along with the object to be stored may be provided to the canvas 152. If the key already exists, the canvas 152 may generate prompts for confirmation before overwriting, thereby preventing accidental data loss. Keys may be marked with additional constraints such as read-only, protected, or format-restricted. Protected keys may be modified under predefined conditions, while format-restricted keys accept only specific types of input (e.g., lists of valid filenames). If a model, agent, and/or other device attempts to violate constraints of the canvas 152, the canvas 152 may return an informative warning to guide corrective action. All updates to the canvas 152 may be logged and/or made visible to users for transparency and to support post-processing. Additionally, a serialized object (e.g., a pickle file) may be created to capture the current state of the canvas 152, enabling session resumption and ensuring data availability for downstream analysis.

In operation, the server 105 may receive a request (e.g., a prompt) indicating a computational problem from the computing device 115 (e.g., via the network 110). The server 105 via the solver application 128 may apply the supervisor model 132A to the computational problem. The supervisor model 132A may be trained using training data including computational simulation data, computational workflows, computational code, multi-modal computational data, multi-fidelity computational data, computational experimental data, and/or any other suitable training data. In at least some aspects, the supervisor model 132A may include an LLM such as a pre-trained open-source LLM, or an LLM trained/fine-tuned to understand computational science concepts using computational science training data.

The supervisor model 132A may generate (i) a workflow for solving the computational problem and (ii) a set of code for solving the computational problem. The HPC agent 136 may determine a respective HPC environment 150 (e.g., an exascale computing environment) satisfying computing resource requirements of the set of code. The computing resource requirements may include processor requirements, memory requirements, code compatibility, node characteristics, and/or any other suitable computing resource requirements. In at least some aspects, to determine the HPC environment 150, the server 105 may obtain HPC information indicating computing resources of the HPC environments 150. The HPC agent 136 may determine the HPC environment 150 that satisfies computing resource requirements of the set of code based at least in part upon the HPC information.

The computing agent 134 may execute the set of code within the respective HPC environment 150 to generate an output associated with solving the computational problem. The HPC agent 136 may control execution of the set of code by the computing agent 134 according to the workflow. The computing agent 134 may be further configured to test the code, troubleshoot the code, generate new code, and/or optimize the code (e.g., code stored in the canvas 152) for the specific HPC environment 150.

In at least some aspects, the validation agent 138 may be configured to validate the output (e.g., stored in the canvas 152) of the code. In response to the output failing validation, the validation agent 138 may perform a corrective action including re-executing the code, debugging the code, selecting a different HPC environment 150 to execute the code, etc.

The server 105 may apply the supervisor model 132A to the output to generate a solution to the computational problem, and provide the solution to the computing device 115.

In at least some embodiments, the server 105 (e.g., via the supervisor model 132A) may determine a domain associated with the computational problem, and select, based upon the domain, a domain-specific model of the plurality of domain-specific models 132B. The supervisor model 132A may include the selected the domain-specific model 132B (e.g., solve the computational problem, generate the code and/or workflow, interact with the agents 134, 136, etc.).

In at least some embodiments, the server 105 may determine (e.g., via the supervisor model 132A) the fidelity of the solution to the computational problem. In response to the fidelity not exceeding a threshold, the supervisor model 132A may generate an alternate workflow and/or alternate code to solve the computational problem. The server 105 may solve the computational problem using the alternate workflow and/or alternate code.

Several of these computing elements (e.g., ML models 132, computing agents 134, HPC agents 136, validation agents 138) will now be discussed in more detail.

### Example Model for Providing a Solution to a Computational Problem

In at least some embodiments, the disclosed techniques include a model (e.g., the supervisor model 132A) trained to provide a solution to a computational problem (e.g., a computational science problem). The model may be trained using pairs of scientific papers and supporting code, dataset targeting code, high-performance scientific codes, and/or any other suitable training data. In at least some aspects, the model may operate on the scale of one hundred billion to one trillion parameters.

The model may be multi-modal LLM that receives as an input (e.g., via a request and/or prompt) a computational problem, such as a research question. Based upon the computation problem, the model may generate code and a workflow associated with solving the computational problem. Solving the computation problem may further include the use of a computing agent (e.g., the computing agent 134) and an HPC agent (e.g., the HPC agent 136) to run large-scale exascale computational campaigns producing computational results associated with a solution to the computational problem.

Training and/or generating the model may include Direct Preference Optimization, Identity Preference Optimization, and/or Kahneman-Tversky Optimization. Model training may include training frameworks such as DeepSpeed and Megatron. Training may include customizing and/or optimizing such frameworks for scientific foundation models. Customizing and/or optimizing the frameworks may include tweaking data flow mechanisms to reduce bandwidth overhead and redesigning memory allocation processes to minimize latency, optimizing for specific computing environments (e.g., AMD GPUs, Intel GPUs), customizing for managing computational loads, and/or optimizing memory usage. In one aspect, the frameworks may (i) maximize computational load management and memory optimization tailored to AMD and Intel GPU architectures; (ii) optimize the trade-offs among memory usage, computational power, and inter-node communication to enhance model training; (iii) implement advanced parallelism strategies including pipeline and tensor parallelism; (iv) fine-tune a Zero Redundancy Optimizer for memory utilization, enabling the training of significantly larger models than currently feasible.

To address the scalability of training large foundation models, pipeline parallelism may split model layers across different GPUs, to provide simultaneous processing of different model parts. Tensor parallelism may divide the computation of tensors across multiple GPUs, to provide larger model training than the memory of a single GPU can accommodate. Training may include the optimization of micro-batch sizes and gradient accumulation for managing the trade-offs between memory usage and computational speed.

Tensor parallelism may divide the tensors involved in neural network computations across multiple GPUs to provide for the execution of larger models than single GPU memory limits may otherwise permit. In one example, during forward and backward propagation, each GPU computes a portion of the output tensors and then these parts are synchronized across GPUs to produce a complete output. Moreover, distributing tensor operations may minimize synchronization overhead that may otherwise become a bottleneck in multi-GPU environments. Adaptive algorithms may dynamically adjust tensor partitioning based on the computational load and real-time network latency.

Pipeline parallelism may efficiently utilize GPUs by partitioning a model into several stages or layers, each of which is processed on different GPUs. Such an approach may allow processing of multiple batches simultaneously in different stages of the pipeline, significantly speeding up the training process. Techniques such as asynchronous execution and predictive loading of data batches may enhance the efficiency of the pipeline parallelism.

Sharded data parallelism may partition training data, model parameters, optimizer states, and gradients across GPUs. Using this approach may reduce the memory footprint of each GPU allowing for larger batch sizes and reducing the frequency of out-of-memory errors, and decrease the communication overhead associated with synchronizing parameters after each gradient update, which may otherwise be a significant performance bottleneck in large-scale training. Techniques to compress the gradients and parameters before communication may further reduce network load and enhance system throughput.

Training may include optimizing the Zero Redundancy Optimizer (Zero) for GPU architecture. Zero may partition model states across multiple GPUs to drastically reduce the memory required per GPU, facilitating the training of larger models. Enhancements to Zero may further reduce memory overhead while maintaining or improving computational efficiency, including advanced compression techniques and smarter data distribution strategies to optimize bandwidth usage and reduce synchronization times between GPUs.

The techniques may parallelize deep learning training tasks by maximizing data locality and minimizing contention of data exchanges.

### Computing Agent

A computing agent (e.g., the computing agent 134) may receive as an input the workflow and code provided by the model, and execute the code in an HPC environment (e.g., the HPC environment 150) to obtain an output (e.g., an output associated with solving a computational problem). The computing agent may further analyze the output for error, uncertainty from the calculations, and the like, providing a closed feedback loop in which the computing agent may self-correct potential calculation errors and/or improve the quality of the overall workflow. The computing agent may provide approaches to multi-fidelity and ways to improve the output of the code.

The computing agent may include one or more models. In some such embodiments, the models may be trained using historical code (e.g., historical code associated with historical workflows to solve historical computational problems), or other suitable training data.

### HPC Agent

An HPC agent (the HPC agent 136) may receive code from the model (e.g., the supervisor model 132A). The HPC agent may receive HPC information (e.g., processor characteristics, memory characteristics, bandwidth, size, availability, cost, etc.) of one or more HPC environments (e.g., exascale computing infrastructure). The HPC agent may analyze the code from the model and generate a resource request (e.g., a job submission script) based on the requirements of the code and HPC information. In some embodiments the HPC Agent may include one or more models. In some such embodiments, the HPC Agent may be trained HPC environment job logs (e.g., at exascale computing facilities). Reinforcement learning algorithms (e.g., with human feedback) may be used for learning (e.g., via a training) optimal resource configurations for a given computational workflow, and may further provide training to learn optimal scheduling policy and dynamically adapt a policy in response to workload changes via dynamic resource prioritizing. Federated learning and social learning strategies may be used to mitigate privacy concerns.

The speed, efficiency, and/or to some extent the precision of scientific computation may be contingent upon the choice of computing hardware and resources. Determining the appropriate HPC computing hardware and/or resources for a given application or simulation may require considering many factors and constraints. Considerations when characterizing a workload may include assessing compute-intensity, memory-intensity, data-intensity, the frequency of communication between processors, and/or the compatibility of code with specific hardware accelerators. The workload characteristics may be matched to the specifications (e.g., memory, bandwidth, configuration, size) of HPC environments.

The HPC agent may deploy code developed and validated by the computing agent to an HPC environment (e.g., the HPC environment 150). The HPC agent may match the computational requirements (e.g., determined based upon the code and workflow) to available HPC resources while accounting for externalities (availability, cost, etc.), frictions (data transfer costs, partition limits, etc.) and the individual peculiarities of each system (MPI implementation, GPU provider, GLIBC, etc.).

Estimating job requirements may include applying reinforcement learning to adaptively refine a computational workflow. By combining extensive, fine-grained job log information with measurements collected during code validation, the HPC agent may automatically match the generated code to appropriate HPC environments and/or the requisite submission scripts. Additionally, the HPC agent may validate the generated scripts against the documentation of each HPC environment (e.g., manual pages, version-specific documentation, site-specific documentation, etc.) to detect possible configuration.

Although submission scripts, output/error logs, and environmental measurements are abundantly available via computational facilities, such data may be highly unstructured and/or contains varying degrees of sensitive or privileged information. To overcome the privacy and security concerns of training directly on these datasets, training may include federated training as a privacy-preserving approach to federated training.

### Example Multi-Modal Learning and Multi-Information Source Fusion Multi-Modal Learning

Embedding techniques may transform raw data into a format that is easier for models to manipulate, compare, and/or analyze semantically rather than syntactically. Converting different types of data into a common format via embedding techniques may be particularly useful to enable the model to uniformly process multi-modal data.

Employing a first technique, TokenFusion, may mitigate the dilution of inner-modal weights in model parameters by detecting and substituting uninformative tokens with projected and aggregated inter-modal features. Furthermore, TokenFusion may incorporate positional alignment capabilities to enable explicit utilization of the inter-modal alignments after fusion, for example to map relationships and learning of correlations between high-level requirements specification from domain scientists, simulations, and experimental observation.

A second technique, ImageBind, may perform pretraining using experiment image-paired data rather than requiring alignment across all modalities. This alternative embedding framework may offer many benefits for domain scientists using the foundation model. For example, ImageBind may promote emergent alignment such as zero-shot recognition and compositionality across modalities not directly paired during training, and enable representation for modalities with fewer datasets.

Another approach may include pre-training a model (e.g., LLaMa) already trained in a single modality, such as text, and incrementally introducing new modalities like images, videos, and code data to leverage and adapt the existing textual knowledge base of the model without starting from scratch. Furthermore, adapters may provide a resource-efficient method to introduce additional modalities when adding small, trainable layers specifically designed for new data types (e.g., visual or auditory inputs), to fine-tune a pre-existing model to perform multi-modal tasks. This method may be particularly valuable for enhancing models with specific capabilities tailored to targeted applications, such as real-time processing in dynamic environments.

### Multi-Information Source Fusion and Multi-Fidelity Modeling

Reasoning about multiple fidelities of information sources may be a key characteristic of computational problems as many ways to approach a given problem may exist. For example, conceptual design using computational tools may be carried out via low-order models, while science-driven questions may require large-scale simulation.

To address model fidelities with different inputs, different parameters, and different requirements, black-box fusion and structured information fusion may be used. The black-box strategy may use the discrete model fidelity as a context within the prediction network, and require large amounts of data as a data-driven approach to discern inter-fidelity relationships. Alternatively, structured approaches may explicitly map relationships such as peer or hierarchical connections using graph-based representations, to reduce the amount of data needed for model training. Hybrid techniques are also possible, treating subsets of model fidelities as black boxes yet allowing for overarching integrations.

Conventional deep-learning-based approaches for solving single-fidelity problems may include representing the solution with a deep neural network to minimize the squared error at a set of collocation points or directly learning the solution operator with, e.g., DeepOnets or Fourier neural operators. Some of the challenges with these methods include (1) achieving convergence to a desired level of precision, (2) finding optimal architectures, (3) determining the correct number of collocation points, and (4) suffering from high computational expenses associated with the minimization procedure. To mitigate these issues, the multi-fidelity approach may introduce additional structure into these types of networks to counteract a lack of data at the highest fidelities. Avoiding reliance on a single high-fidelity set of equations may alleviate heavy computational burdens arising from problem dimensionality and resolution requirements. Using a foundation-model framework that fuses information from an ensemble of available sources of varying accuracy and cost into a single model may improve the accuracy of predictions, especially in practical cases where only limited (e.g., sparse) numerical simulation and physical experiment data may exist.

### Multi-Fidelity Workflows

Structured queries and training methods may provide the model knowledge of fidelity variations and their origins (e.g., extracting modeling assumptions such as the simplification of physical laws or numerical resolutions and their potential impacts on predictive accuracy). The model may be trained to formulate queries from lower-fidelity models, and assess the sufficiency of their accuracy (e.g., by providing underlying assumptions associated with the lower-fidelity model).

The model may access and query a variety of models, and integrate and interpret their outputs cohesively. For example, in a climate modeling scenario, the model might draw on low-fidelity models for broad climate patterns while integrating high-fidelity data for localized weather events to provide more accurate predictions for a specific region without the computational cost of running high-fidelity models globally. The model may weigh results from different fidelities, using lower-level data to bind the problem space and refine the search with high-fidelity calculations where necessary. Adaptive workflows may dynamically select the fidelity level based on the desired accuracy and available computational resources. Integrating multi-fidelity models may provide more nuanced predictions that incorporate broad expertise and data sources.

### Verification and Validation

The systems and methods may verify and validate the outputs of foundational models via a validation agent (e.g., the validation agent 138). To verify code outputs, peer reviews may check for logical errors and self-review to ensure understanding of each line of the suggested code. A scalable, open-source software workflow and infrastructure may evaluate foundation models against a set of predefined scientific benchmarks and datasets. The evaluation may include several phases: (i) model acquisition: via a software environment for downloading and integrating fine-tuned models into the evaluation framework; (ii) benchmarks and model testing: develop and analyze benchmarks to understand application-specific aspects such as bias and adversarial robustness; (iii) system integration: integrate benchmarks with the foundation models including managing data inputs, executing benchmark tests, and effectively handling output data with provisions for scalability and adaptability; (iv) testing and data collection: tests to evaluate the models using different scenarios, tasks, metrics, and datasets and recording the models' responses and performance metrics; (v) data analysis: analyze the collected data to draw conclusions on model performance using statistical methods, identifying patterns and anomalies and comparing performances across benchmarks; (vi) documentation: generate comprehensive reports that document the methodologies, analysis, and insights from the evaluation, detail the trustworthiness perspectives included in the benchmarks, and provide an overview of the findings.

In any event, returning to FIG. 1, the at least one server 105 may include only one server, or multiple servers that are co-located and/or remotely distributed. The server 105 may be part of a cloud network or may otherwise communicate with other hardware or software components within one or more cloud computing environments to send, retrieve, or otherwise analyze data or information described herein. In some example embodiments, the computing environment 100 comprises an on-premise computing environment, a multi-cloud computing environment, a public cloud computing environment, a private cloud computing environment, and/or a hybrid cloud computing environment.

The example computing environment 100 includes a network 110 comprising any suitable network or combination of networks, such as a local area network (LAN), a wide area network (WAN), the Internet, or a combination thereof. For example, the network 110 may include a wireless cellular network (e.g., 4G, 5G, 6G, etc.). Generally, the network 110 enables bidirectional communication between the server 105, the computing device 115, and/or the HPC environments 150. In one embodiment, the network 110 comprises a cellular base station, such as cell tower(s), communicating to the one or more other components of the computing environment 100 via wired/wireless communications based upon any one or more of various mobile phone standards, including NMT, GSM, CDMA, UMTS, LTE, 5G, 6G, or the like. Additionally, or alternatively, the network 110 may comprise one or more routers, wireless switches, and/or other such wireless nodes communicating with the components of the computing environment 100 via wired and/or wireless communications based upon any one or more of various communications standards, including by non-limiting example, IEEE 802.11a/ac/ax/b/c/g/n (Wi-Fi), Bluetooth, and/or the like.

The example server 105 includes processor 120. The processor 120 includes one or more processors, such as central processing units (CPUs), graphics processing units (GPUs), and/or any other suitable processor. The processor 120 is communicatively coupled to a memory 124 via a computer bus (not depicted) to create, read, update, transmit, delete, or otherwise access or interact with the data, data packets, or otherwise electronic signals to and from the processor 120 and the memory 124, e.g., in order to implement or perform the machine-readable instructions, methods, processes, elements, or limitations, as illustrated, depicted, or described for the various flowcharts, illustrations, diagrams, figures, and/or other disclosure herein. The processor 120 interfaces with the memory 124 via a computer bus to execute an operating system and/or computing instructions stored in the memory 124, and/or to access other services/components/etc. For example, the processor 120 may interface with the memory 124 via the computer bus to create, read, update, delete, or otherwise access or interact with the data stored in the memory 124 and/or database 130.

The server 105 may include a network interface 122 which allows the server 105 to communicate over the network 110 (e.g., with the computing device 115, a databases 130, the HPC environment 150) via any suitable wired and/or wireless connection, e.g., using any suitable network interface controller(s) of the network interface 122. The network interface 122 may include one or more transceivers (e.g., wireless WAN (WWAN), wireless LAN (WLAN), and/or wireless personal area network (WPAN) transceivers) functioning in accordance with IEEE reference standards, 3GPP reference standards, and/or other reference standards that may be used in receipt and transmission of data via external/network ports of the server 105 connected to computer network 110.

The memory 124 may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, etc. The memory 124 stores machine-readable instructions executable by the processor 120, including the instructions of one or more application(s) 126. The memory 124 also stores an operating system (e.g., Microsoft Windows, Linux, UNIX, etc.) capable of facilitating the functionalities, applications, methods, or other software of the applications 126 as discussed herein.

The memory 124 may also store a plurality of computing modules 142, implemented as respective sets of computer-executable instructions as described herein. In one embodiment, the computing modules 142 include an ML module 144 comprising a set of computer-executable instructions implementing ML loading, configuration, initialization, and/or operation functionality. In some embodiments, at least one of a plurality of ML methods and algorithms is applied by the ML module 144, where the ML methods and algorithms may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning. In one aspect, the ML based algorithms may be included as a library or package executed on the server(s) 105. For example, libraries may include the TensorFlow based library, the PyTorch library, and/or the scikit-learn Python library.

In one embodiment, the ML module 144 employs supervised learning, which involves identifying patterns in existing data to make predictions about subsequently received data. Specifically, the ML module is “trained” using training data, which includes example inputs and associated example outputs. Based upon the training data, the ML module 144 may generate a predictive function which maps outputs to inputs and may utilize the predictive function to generate ML outputs based upon data inputs. The example inputs and example outputs of the training data may include any of the data inputs or ML outputs disclosed herein. In example embodiments, a processing element is trained by providing it with a large sample of data with known characteristics or features.

In another embodiment, the ML module 144 may employ unsupervised learning, which involves finding meaningful relationships or patterns in unorganized data. Unlike supervised learning, unsupervised learning does not involve user-initiated training based upon example inputs with associated outputs. Rather, in unsupervised learning, the ML module 144 may organize unlabeled data according to a relationship determined by at least one ML method/algorithm employed by the ML module 144. Unorganized data may include any combination of data inputs and/or ML outputs as described above.

In yet another embodiment, the ML module 144 may employ reinforcement learning, which involves optimizing outputs based upon feedback from a reward signal. Specifically, the ML module 144 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The ML module 144 may receive labeled data at an input layer of a model having a networked layer architecture (e.g., an artificial neural network, a convolutional neural network, etc.) for training the one or more ML models 132. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models 132. The output layer may be trained to output a prediction, for example.

In operation, ML module 144 may access the database 130, or any other data source, for training data suitable to generate one or more ML models. The training data may be sample data with assigned relevant and comprehensive labels (classes or tags) used to fit the parameters (weights) of an ML model with the goal of training it by example. In one aspect, once an appropriate ML model is trained and validated to provide accurate predictions and/or responses, the trained model may be loaded into ML module 144 at runtime to process input data and generate output data. As discussed, once trained, the one or more trained ML models may be operated in inference mode, whereupon when provided with de novo input that the model has not previously been provided, the model may output one or more predictions, classifications, etc., as described herein. The ML module 144 may include instructions for storing the trained ML models 132 (e.g., in the memory 124, in electronic database 130, etc.).

In certain embodiments, the ML module 144 may employ natural language processing (NLP) functions to train one or more ML models, which may also utilize NLP functions/algorithms/models. NLP generally involves understanding verbal/written communications and generating responses to such communications. The ML models described herein may be trained to perform such NLP functionality using a symbolic method, machine learning models, and/or any other suitable training method. As an example, the ML models described herein may be trained to perform at least two techniques that may enable the ML models to understand words spoken/written by a user: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (POS) tagging, parsing, lemmatization and stemming, stop-word removal, and/or any other suitable sub-task or combinations thereof. For example, using syntactic analysis, the ML models described herein may generate textual transcriptions from verbal responses from a user in a data stream.

Semantic analysis generally involves analyzing text in order to understand and/or otherwise capture the meaning of the text. In particular, the ML models described herein applying semantic analysis may study the meaning of each individual word contained in a textual transcription in a process known as lexical semantics. Using these individual meanings, the ML models described herein may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the ML models described herein may generate one or more intent interpretations based upon one or more textual transcriptions from a syntactic analysis.

In various embodiments, examples, and/or aspects disclosed herein may include training and generating one or more ML models for the server 105 to load at runtime. Additionally, or alternatively, one or more appropriately trained ML models may already exist (e.g., in the database 130) such that the server 105 may load an existing trained ML model at runtime. In some implementations, server 105 may retrain, fine-tune, update and/or otherwise alter an existing ML model before and/or after loading the model at runtime.

In one aspect, the computing modules 142 include an I/O module 146, comprising a set of computer-executable instructions implementing communication functions. The I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch sensitive input panels, keys, buttons, lights, LEDs), which may be directly accessible via, or attached to, server 105 or may be indirectly accessible via or attached to the computing device 115.

The server 105 may also be in communication with a computing device 115. The computing device 115 may comprise one or more computers and/or multiple, redundant, or replicated client computers accessible to one or more users. The computing device 115 may include one or more computing devices (e.g., desktop computer, laptop computer, terminal), mobile devices, wearables, smart watches, smart contact lenses, smart glasses, augmented reality glasses/headsets, virtual reality glasses/headsets, mixed or extended reality glasses/headsets, and/or other suitable electronic or electrical components. The computing device 115 may include a processor (e.g., the processor 120) and a memory (e.g., the memory 124) for, respectively, storing and executing one or more modules, computer-executable instructions, etc. The memory may include one or more suitable storage media such as a magnetic storage device, a solid-state drive, random access memory (RAM), etc. The computing device 115 may include a network interface (e.g., the network interface 122) to access services or other components of the computing environment 100 via the network 110. The memory of the computing device 115 may include an operating system and a plurality of software applications. The software applications of the computing device 115 may include a solver client application. The user of the computing device 115 may execute the solver client application to, for example, provide requests indicating a computation problem to the server 105 over the network 110, and/or to receive a solution to computational problem from the server 105 (e.g., via the solver application 128).

The computing environment 100 may include additional, fewer, and/or alternate components, and may be configured to perform additional, fewer, or alternate actions, including components/actions described herein. For instance, information described as being stored at database 130 may be stored at memory 124, and therefore database 130 may be omitted. Moreover, it should be appreciated that additional and/or alternative connections between components shown in FIG. 1 may be implemented. As just one example, server 105 and database 130 may be connected via a direct communication link (not shown in FIG. 1) instead of, or in addition to, via the network 110.

### Example Machine Learning Model Training

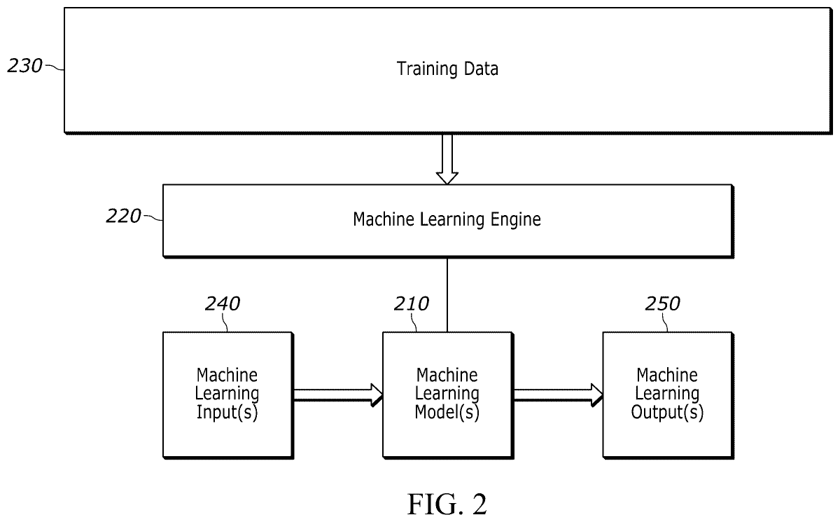

FIG. 2 illustrates a flow diagram for example training and operation of an ML model 210 (e.g., the ML models 132, 132A, 132B), according to some embodiments. The example training and/or operation of the ML model 210 may be performed by the computing environment 100.

An ML engine 220 (e.g., the ML module 144 of the server 105) may include one or more hardware and/or software components to obtain, create, (re) train, fine-tune, and/or store one or more ML models, such as the ML model 210. To train the ML model 210, the ML engine 220 may use training data 230. A server, such as server 105, may obtain and/or have available one or more types of training data 230 (e.g., training data stored in the database 130). In one aspect, at least some of the training data 230 may be labeled to aid in (re) training and/or fine-tuning the ML model 210. During training of the ML model 210 by the ML engine 220, the ML model 210 may be configured to process the training data 230 to learn associations and relationships in the training data 230.

In some embodiments, the ML engine 220 updates the training data 230 as needed, e.g., to include new data. Such data may be stored as updated training data 230. Subsequently, the ML model 210 may be retrained based upon the updated training data 230, or the new portions thereof, which may cause the ML model 210 to improve (e.g., make more accurate predictions) over time.

In some embodiments, the ML engine 220 trains the ML model 210 using the training data 230 to generate the output 250 based on receiving the input 240. Once trained, the ML model 210 may perform operations on one or more data inputs 240 to produce a desired data output 250, as discussed above. In one aspect, the ML model 210 is loaded at runtime from a database (e.g., the model 210 loaded by the ML engine 220 from the database 130). The server and/or ML engine 220 may obtain the input data 240 (e.g., from the database 130), and the ML engine 220 may provide the input data 240 to the trained ML model 210 as an input, for the ML model 210 to generate the output 250.

In at least some aspects, the same server and/or other suitable component/device, both trains the ML model 210, and executes the trained ML model 210. In at least some aspects, a first server and/or other suitable component/device trains the ML model 210, and a second server and/or other suitable component/device executes the trained ML model 210.

In one embodiment, the ML model 210 is a generative ML model, e.g., a model trained by ML engine 220 to include generative functionality for creating new content that is in some ways similar to, or otherwise inspired by, existing examples, and/or reflective of desired features/characteristics. In at least some embodiments, the generative ML model is and/or includes an LLM. The LLM may operate upon and generate only text or, in other embodiments, may be a multi-modal LLM that operates upon and/or generates text and also other types of content (e.g., images, audio, etc.).

To use the generative ML model, in at least some embodiments the server (e.g. the server 105) receives a text prompt (e.g., a request indicating a computational problem). The server may provide the prompt as an input to the generative ML model, causing the generative ML model to process the text prompt and output text content responsive to the text prompt. The generative ML model may include a deep neural network and may perform various natural language processing (NLP) tasks (e.g., classifying text, answering questions, summarizing text, generating text) as needed to understand a text query/prompt and generate a response to the text query/prompt.

The LLM may have a transformer model architecture with an encoder and decoder, and may characteristics tokenize inputs/text. The transformer model may incorporate self-attention mechanisms to facilitate faster learning/training and/or more accurate output. In some embodiments, the LLM includes many layers of neural networks, possibly including a number of embedding layers, a number of feedforward layers, and a number of recurrent layers. In alternative embodiments, the generative ML model is not an LLM. For example, the generative ML model may instead include a less complex neural network.

The generative ML model may have been trained by server 105 or another computing system using unsupervised or semi-supervised learning, for example, and with training data of the appropriate modality (text) or modalities (e.g., text as well as images and/or audio). In some aspects, the generative ML model may be a general-purpose model (e.g., trained on a wide array of publicly available datasets such as web pages, documents, etc., available via the Internet). In some aspects, the generative model may be a publicly available and/or open source pre-trained model (e.g., LLaMa 3, GPT-4).

In some aspects, the generative model may be a domain-specific model (e.g., trained on custom and/or proprietary datasets). For example, a pre-trained generative LLM may be fine-tuned to generate a plurality of domain-specific models, including domains such as physics, chemistry, biology, density functional theory, engineering, neuroscience, combustion, astrophysics, materials science, and/or other computational sciences. In another example, the generative ML model may be the LLM with parameters tuned, via the training process, specifically for high performance in the context of generating code to solve computational problems.

### Example Computational Problem and Solution

Density functional theory (DFT) is a first-principles atomistic simulation method in computational materials science for material property prediction. Performing high-fidelity DFT calculations may require a substantial understanding of theoretical methodology, the technical skills to execute scientific software in one or more HPC environments (e.g., the HPC environment 150), and/or understand the level of theory and numerical methods implemented via software. For solid materials, a first class of simulations may include DFT simulation of bulk systems using the periodicity of bulk solids in all directions to reduce computational cost and predict bulk solid properties including crystal space group, lattice constant, bulk modulus, etc. Among these properties, crystal lattice constants serve as a cornerstone property by defining crystal periodicity.

The second class of DFT simulations may include modeling surface systems by modeling how surfaces are constructed and how adsorbates and reactions occur on surfaces, for example in catalysis, interfaces, membrane transport, and similar applications. In such systems, the periodic boundary condition (PBC) may not be enforced in the direction normal to the surface, differentiating such simulations from bulk simulations. One known problem of surface DFT simulations is the CO/Pt (111) puzzle, which concerns the adsorption of carbon monoxide (CO) on platinum 111 (Pt(111)) surfaces. The choice of exchange-correlation functional, which may be critical in high-fidelity DFT simulations, may have a significant effect on the adsorption energy results, suggesting high uncertainty in the functional choice. To evaluating this uncertainty, Bayesian statistics may sample an ensemble of functionals that can be evaluated non-self-consistently, for example DFT simulation of magnetic properties, elastic properties, finite-temperature thermodynamic properties, surface phase diagrams, etc. The disclosed systems and methods address complex scientific challenges, such as those just described in computational materials science, and/or other scientific fields via a system architecture (e.g., the computing environment 100) implementing the reasoning capabilities of various tools and model (e.g., the solver application 128, the models 132) along with domain-specific tools (e.g., the plurality of domain-specific models 132B).

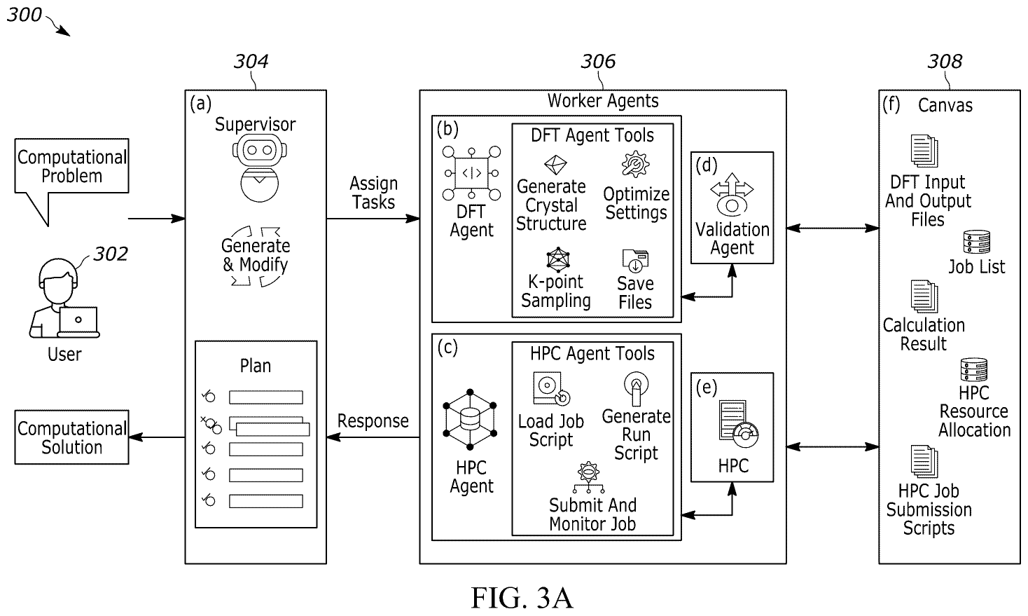

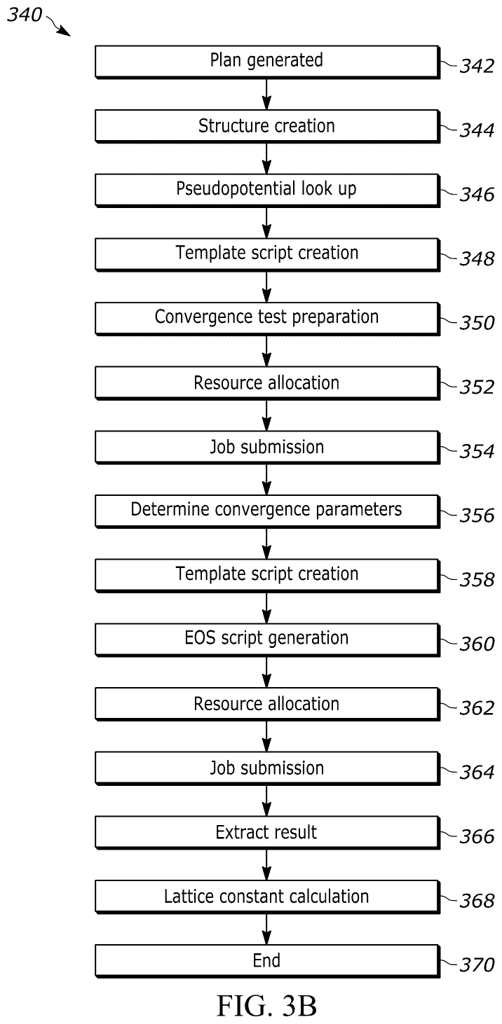

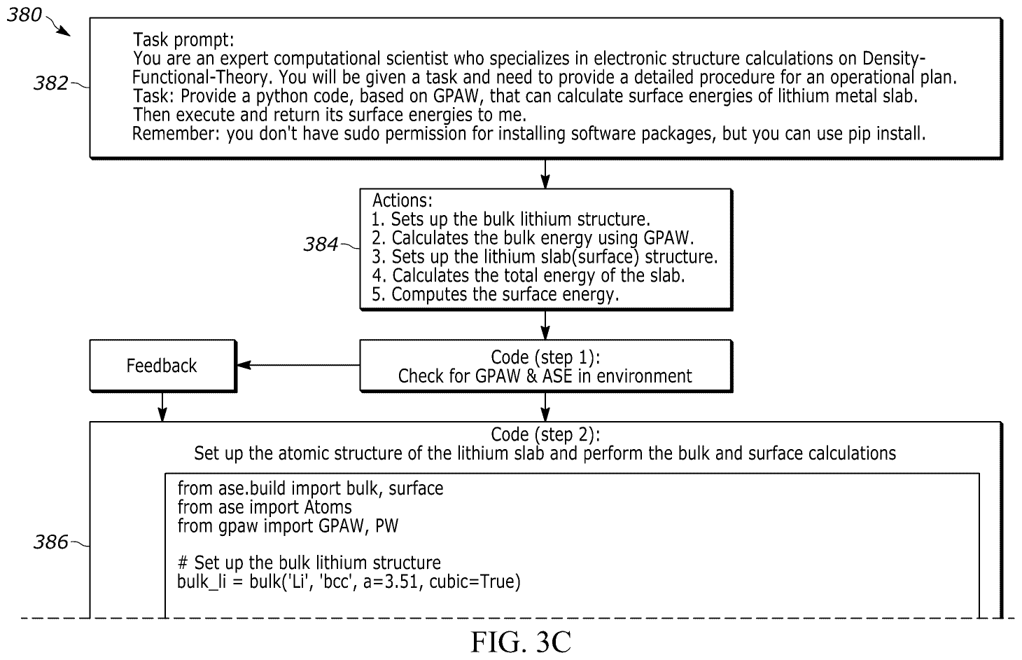

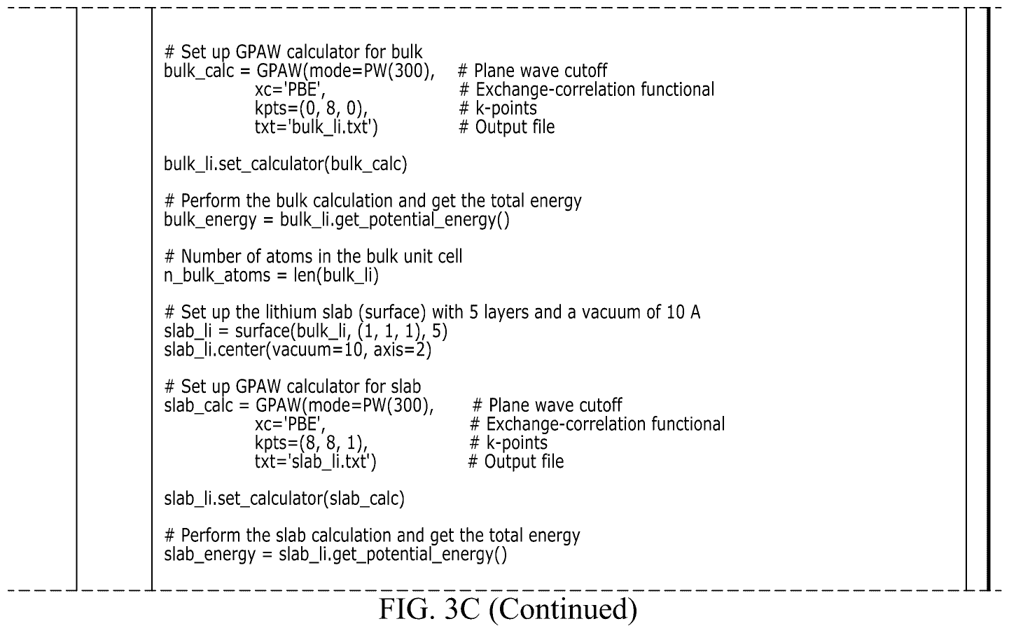

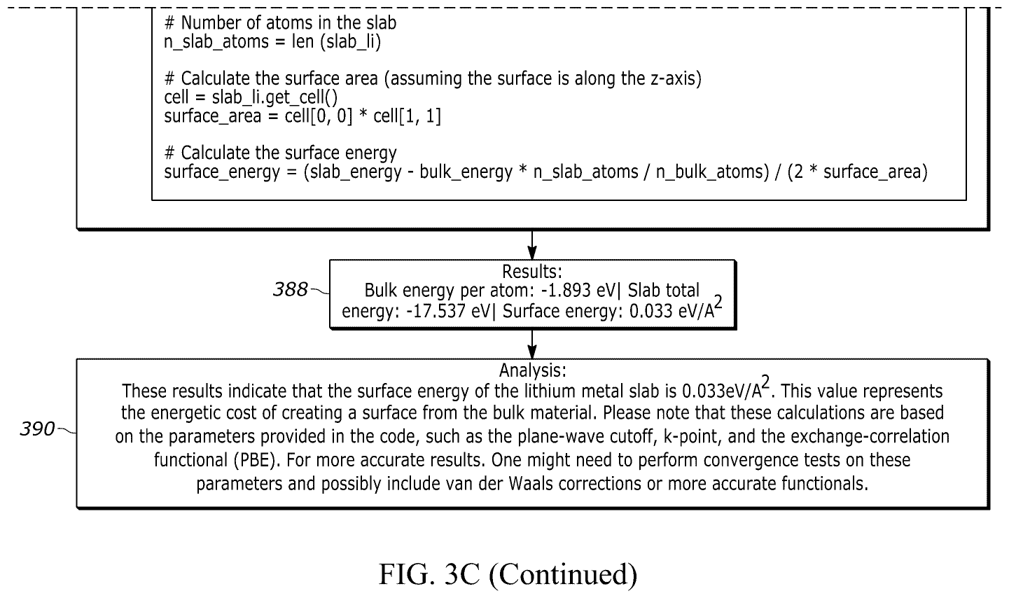

FIG. 3A depicts a block diagram of an example high-level workflow 300 for solving a computation materials science problem, according to some embodiments. According to the high-level workflow 300, a user 302 generates a computational problem, for example a computational problem associated with the aforementioned lattice constant for a one or more elemental solids and/or the CO adsorption on a Pt (111) surface. The user 302 may generate the computational problem via a solver application (e.g., the solver application 128) executing on a computing device (e.g., the computing device 115).

The solver application and/or otherwise computing device may transmit the computational problem (e.g., via the network 110) to a supervisor agent 304 (e.g., the supervisor model 132A) executed via a server (e.g., the server 105). For example, the solver application of the computing device may transmit the computational problem to a solver application of the server executing the supervisor agent 304. In at least some embodiments, a solver application (e.g., executing at the computing device and/or the server) may generate one or more prompts associated with the computational problem, and provide the prompts to the supervisor agent 304.

For example, the computational problem may include calculating a lattice constant for a one or more of elemental solids, such as species of crystal structures. For each species of crystal structure, the solver application may generate one or more prompts including: “You are going to calculate the lattice constant for <Crystal structure> <Species> using density functional theory. The experimental value is <xxx>. Create the initial crystal structure using this information.”

Based upon receiving the one or more prompts, the supervisor agent 304 may generate a lattice workflow of tasks (e.g., simulations, data extraction, and resource management) to solve the computational problem. For example, the tasks may include:
1. Create initial structure of body-centred cubic of Lithium (BCC Li) with experimental lattice constant of 3.451 Å;
2. Find appropriate pseudopotential for Li;
3. Write initial DFT script for BCC Li;
4. Generate convergence test input files for cutoff energy and k-points;
5. Add resource suggestions for convergence test jobs;
6. Submit convergence test jobs to HPC and monitor completion;
7. Determine optimal parameters from convergence test results;
8. Generate equation of state (EOS) calculation input files using optimal parameters;
9. Add resource suggestions for EOS calculation jobs;
10. Submit EOS calculation jobs to HPC and monitor completion;
11. Read output files to extract energy values;
12. Calculate equilibrium lattice constant from EOS data; and
13. Compare calculated lattice constant with experimental value and report results.

The supervisor agent 304 may generate one or more prompts and/or code associated with the lattice workflow, the associated tasks, and/or otherwise computational problem. The supervisor agent 304 and/or otherwise solver application 128 may implement one or more models (e.g., the plurality of domain-specific models 132B) and/or agents (e.g., the computing agent 134, HPC agent 136, and/or validation agent 138), collectively referred to as “worker agents” 306 in FIG. 3A, to solve the computation problem by performing the lattice workflow tasks in one or more HPC environments (e.g., the HPC environment 150). Accordingly, the supervisor agent 304 may delegate one or more tasks of the lattice workflow to the worker agents 306. One or more of the supervisor agent 304 and/or the worker agents 306 may have access to a canvas (e.g., the canvas 152) which may be used storage and/or retrieval of data associated with solving the computational problem of the lattice workflow.

FIG. 3B depicts an example flowchart 340 for performing the lattice workflow tasks associated with calculating a lattice constant, according to some embodiments. The flowchart 340 may include the supervisor agent 304 generating the lattice workflow of tasks at block 342. To perform one or more of the lattice workflow tasks, the worker agents 306 may include at least one DFT agent (e.g., a domain-specific model 132B, the worker agent 306). Blocks 344, 346, 348, and 350 of the flowchart 340 may coincide with the DFT agent) performing lattice workflow tasks 1, 2, 3, and 4 of the lattice workflow, respectively. Similarly, blocks 356, 358, 360, 366 and 368 may coincide with worker agents 306 that includes at least one DFT agent performing lattice workflow tasks 7, 8, 9, 12, and 13 of the lattice workflow, respectively.

The DFT agent may include one or more models trained to perform computational chemistry focused on high-fidelity density functional theory calculations. The DFT agent may be trained to manage scientific aspects of electronic structure calculations, such as construction of atomistic models, optimization of computational parameters, analysis of calculation results, etc. For example, the DFT agent may perform tasks including generating atomistic structures such as bulk crystals, surfaces, and adsorbate configurations; determining DFT parameters through systematic convergence testing; preparing input files for performing quantum chemistry functions; and analyzing outputs and extract physical properties such as lattice constants and adsorption energies. To perform such tasks, the DFT agent and or other agents may be configured with, and/or have access to (e.g., via the solver application 128), one or more tools which may be selected tools based on their associated functionalities. The tools of the DFT agent, and/or other agent and/or model, may be interfaced via frameworks such as the Atomic Simulation Environment (ASE), preventing unsafe operations like direct file manipulation, which can otherwise lead to invalid structures or runtime failures. Each tool may maintain explicit input-output mappings and/or implement comprehensive error handling. For example, an adsorption energy tool implemented by the DFT agent may generate three output files (e.g., clean slab, isolated adsorbate, and adsorbate-on-slab) and/or apply standard thermodynamic formulas to compute results. Such an architecture may prevent the use of hallucinated parameters or unphysical equations, and/or provide scientific correctness. A batch modification tool perform convergence testing, enabling the rapid generation of Quantum ESPRESSO (QE) scripts based on a template which may reduce the complexity of script generation from O(N) to O(1) by modifying only the specified convergence parameters while preserving the remainder of the input, which can significantly lowering the risk of inconsistencies or human error.

To perform one or more of the lattice workflow tasks, the worker agents 306 may include at least one HPC agent. Blocks 352, 354, 362, and 364 of the flowchart 340 may coincide with the HPC agent (e.g., the HPC agent 136) performing lattice workflow tasks 5, 6, 10, and 11 of the lattice workflow, respectively. The HPC agent may perform tasks associated with managing specialized high performance computing resources including one or more of optimizing resource allocation based on the complexity of a calculation, scheduling and submitting DFT calculations to one or more appropriate HPC environment (e.g., the HPC environments 150), monitoring calculation status and progress, retrieving and/or organizing output files (e.g., via the canvas 152) upon completion, etc. The HPC agent may dynamically selects computational parameters (e.g., node count, processor allocation, partition, and walltime) of one or more HPC environments based on calculation-specific information, such as system size, calculation type, and settings. The HPC agent may include, and/or have access to, one or more associated tools. For example, to calculate submission, the HPC agent may employ a Python Simple Queuing System Adapter (pysqa) providing seamless integration with Slurm-based HPC environments.

The worker agents 306 may include at least one validation agent (e.g., the validation agent 138). The validation agent may include one or more language models, such as a large language model (LLM). The validation agent may include, and/or have access to, one or more associated tools. For example, the DFT agent may indicate and/or the convergence agent may detect, a job has encountered a convergence issue. The validation agent may implement a tool which locates (e.g., in the canvas 308) one or more associated files for that job and, for each file, generate on or more prompts (e.g., processed by the LLM) include the query: “Here is the content of the file <content>. Please provide suggestions on how to fix the convergence issue.” In response, the LLM may provide a structured and concise response to the query. Operational tasks, such as parameter parsing and preprocessing, may be handled deterministically allowing the LLM to exclusively perform on decision-making and/or process context-specific queries without the complexity of managing inter-agent interactions, which can enhance both the robustness and success rate of convergence handling. The convergence agent may provide suggestions in parameter setting and script generation, the reasoning process, and/or enable the DFT agent to self-correct and conduct updated calculations.

Upon completion of the steps of the lattice workflow, the flowchart 340 may include the supervisor agent 304 providing the computation problem solution (e.g., the calculated lattice constant) to the to the computing device of the user 302 to end 370 the lattice work.

FIG. 3C depicts a block diagram of an example workflow 380 for solving an example surface energy computational problem, according to some embodiments. The user 302 may generate and submit to the supervisor agent 304 via the computing device the surface energy computational problem. Based upon the computational problem, the solver application may generate one or more prompts 382 including: “You are an expert computational scientist who specializes in electronic structure calculations on density functional theory. You will be given a task and need to provide a detailed procedure for an operational plan. Task: Provide a python code, based on GPAW, that can calculate surface energies of lithium metal slab. Then execute and return its surface energies to me. Remember: you don't have pseudo-permission for installing software packages, but you can use pip install.”

The supervisor agent 304 may generate an example surface energy workflow 384 and/or code 386 associated with solving the surface energy computational problem. The example surface energy workflow 384 and/or code 386 may be associated with setting up both the bulk and slab structures, calculating the potential energies, and deriving the surface energies based on the bulk and slab results. The supervisor agent 304 may generate one or more steps tasks of the example surface energy workflow 384, for example to evaluate the correctness of the software environment by writing code to check whether Atomic Simulation Environment is installed. The worker agents 306 may perform one or more tasks of the surface energy workflow 384 using the code 386. For example, the HPC agent may determine one or more HPC environments suitable for executing the code. A computing agent (e.g., the computing agent 134) may execute the code in the HPC environment, for example at the direction of the HPC agent. The output 388 of the code 386 may indicate the surface energy of lithium. The validation agent may validate the results of the code output, for example by determining the surface energy of lithium output by the code is close the surface energy of lithium described in a recent research paper. The supervisor agent 304 may generate a solution 390 based upon the output 388, and provide the solution 390 to the user's computing device.

### Example Method for Solving Computational Problems Using High-Performance Computing

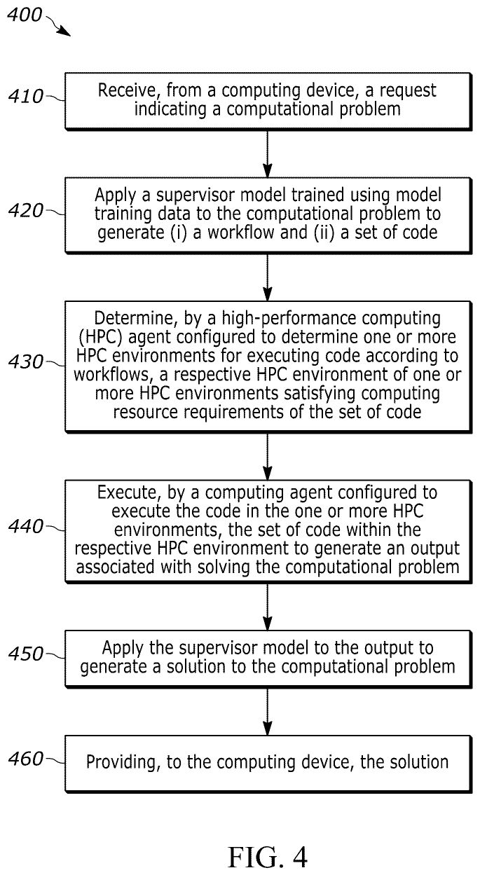

FIG. 4 depicts a flow diagram of an example method 400 for solving computational problems using HPC, according to some embodiments. One or more blocks of the method 400 may be implemented as a set of instructions stored on a computer-readable memory and executable on one or more processors. The method 400 may be implemented via one or more local or remote processors such as the processor 120, servers such as the server 105, HPC environments such as the HPC environment 150, systems such as the computing environment 100, and/or other electronic or electrical components, which may be communicatively coupled with one another.

The method 400 may include receiving, by one or more processors from a computing device, a request indicating a computational problem (block 410). The request may include one or more prompts.

The method 400 may include applying, by the one or more processors, a supervisor model trained using model training data to the computational problem to generate (i) a workflow and (ii) a set of code (block 420). The model training data may include one or more of: computational simulation data, computational workflows, computational code, multi-modal computational data, multi-fidelity computational data, or computational experimental data. The supervisor model may include a large language model (LLM). The LLM may include a pre-trained LLM fine-tuned using computational science training data to generate and/or understand computational science concepts.

The method 400 may include determining, by a high-performance computing (HPC) agent configured to determine one or more HPC environments for executing code according to workflows, a respective HPC environment of one or more HPC environments satisfying computing resource requirements of the set of code (block 430). The HPC environment may include an exascale computer. The computing resource requirements may include one or more of: processor requirements, memory requirements, code compatibility, or node characteristics.

The method 400 may include executing, by a computing agent configured to execute the code in the one or more HPC environments, the set of code within the respective HPC environment to generate an output associated with solving the computational problem (block 440), wherein the HPC agent controls execution of the set of code by the computing agent according to the workflow. The computing agent may be further configured to one or more of: test the code, troubleshoot the code, generate new code, or optimize the code for a specific HPC environment.

The method 400 may include applying, by the one or more processors, the supervisor model to the output to generate a solution to the computational problem (block 450), and providing, by the one or more processors to the computing device, the solution (block 460).

In some embodiments, the method 400 may include determining, by the one or more processors, a domain associated with the computational problem; and selecting, by the one or more processors, based upon the domain, a domain-specific model of a plurality of domain-specific models trained using respective domain-specific training data to provide solutions to respective domain-specific computational problems. The supervisor model may include the domain-specific model. The one or more of the plurality of domain-specific models may be multi-modal models. The domain may be selected from a group consisting of: physics, chemistry, biology, density functional theory, engineering, neuroscience, combustion, astrophysics, and materials science.

In some embodiments, the method 400 may include validating, by a validation agent configured to validate the output of the code, the code; and performing, by the validation agent, a corrective action responsive to the output failing validation. The corrective action includes one or more of: re-executing the code, debugging the code, or selecting a different HPC environment.

In some embodiments, the method 400 may include determining, by the one or more processors, a fidelity of the solution to the computational problem; and generating, by the one or more processors, an alternate workflow and/or alternate code to solve the computational problem based upon the fidelity not exceeding threshold fidelity.

In some embodiments, the method 400 may include obtaining, by the one or more processors, HPC information indicating computing resources of the one or more HPC environments, wherein determining, by the HPC agent, the respective HPC environment satisfying computing resource requirements of the set of code is based at least in part upon the HPC information. The computing resources include one or more of: processor characteristics, memory characteristics, bandwidth, size, availability, or cost.

It should be understood that not all blocks of the example flow diagram of FIG. 4 are required to be performed.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A system comprising:
one or more processors;
one or more memories;
a supervisor model, stored on the one or more memories, trained using model training data to provide respective solutions to computational problems, including generating (i) workflows and (ii) code for solving the computational problems;
a high-performance computing (HPC) agent stored on the one or more memories and configured to determine one or more HPC environments for executing the code according to the workflows;
a computing agent stored on the one or more memories and configured to execute the code in the one or more HPC environments; and
the one or more memories storing instructions that, when executed by the one or more processors, cause the system to:
receive, from a computing device, a request indicating a computational problem,
apply the supervisor model to the computational problem to generate (i) a workflow and (ii) a set of code,
determine, by the HPC agent, a respective HPC environment of the one or more HPC environments satisfying computing resource requirements of the set of code;
execute, by the computing agent, the set of code within the respective HPC environment to generate an output associated with solving the computational problem, wherein the HPC agent controls execution of the set of code by the computing agent according to the workflow,
apply the supervisor model to the output to generate a solution to the computational problem, and
provide, to the computing device, the solution.

2. The system of claim 1, further comprising:
a plurality of domain-specific models stored on the one or more memories trained using respective domain-specific training data to provide solutions to respective domain-specific computational problems; and
the instructions, when executed by the one or more processors, further cause the system to:
determine a domain associated with the computational problem, and
select, based upon the domain, a domain-specific model of the plurality of domain-specific models, wherein the supervisor model includes the domain-specific model.

3. The system of claim 2, wherein one or more of the plurality of domain-specific models are multi-modal models.

4. The system of claim 2, wherein the domain is selected from a group consisting of: physics, chemistry, biology, density functional theory, engineering, neuroscience, combustion, astrophysics, and materials science.

5. The system of claim 1, wherein the supervisor model includes a large language model (LLM).

6. The system of claim 5, wherein the LLM is a pre-trained LLM fine-tuned using computational science training data to generate and/or understand computational science concepts.

7. The system of claim 1, wherein the model training data includes one or more of: computational simulation data, computational workflows, computational code, multi-modal computational data, multi-fidelity computational data, or computational experimental data.

8. The system of claim 1, wherein one or more of:
the HPC environment includes an exascale computer; or
the computing resource requirements include one or more of: processor requirements, memory requirements, code compatibility, or node characteristics.

9. The system of claim 2, wherein at least a portion of the one or more memories stores data associated with solving the computational problem and is accessible to one or more of the supervisor model, the HPC agent, the computing agent, or the plurality of domain-specific models.

10. The system of claim 1, wherein the computing agent is further configured to one or more of: test the code, troubleshoot the code, generate new code, or optimize the code for a specific HPC environment.

11. The system of claim 1, wherein the request is a prompt.

12. The system of claim 1, further comprising:
a validation agent stored on the one or more memories and configured to validate the output of the code; and
instructions that, when executed by the one or more processors, cause the system to:
validate, by a validation agent configured to validate the output of the code, the code; and
perform, by the validation agent, a corrective action responsive to the output failing validation.

13. The system of claim 12, wherein the corrective action includes one or more of re-executing the code, debugging the code, or selecting a different HPC environment.

14. The system of claim 1, further comprising instructions that, when executed by the one or more processors, further cause the system to:
determine a fidelity of the solution to the computational problem; and
responsive to the fidelity not exceeding threshold fidelity, generating an alternate workflow and/or alternate code to solve the computational problem.

15. The system of claim 1, further comprising instructions that, when executed by the one or more processors, further cause the system to:
obtain HPC information indicating computing resources of the one or more HPC environments,
wherein to determine, by the HPC agent, the respective HPC environment satisfying computing resource requirements of the set of code is based at least in part upon the HPC information.

16. The system of claim 15, wherein the computing resources include one or more of: processor characteristics, memory characteristics, bandwidth, size, availability, or cost.

17. A method comprising:
receiving, by one or more processors from a computing device, a request indicating a computational problem;
applying, by the one or more processors, a supervisor model trained using model training data to the computational problem to generate (i) a workflow and (ii) a set of code;
determining, by a high-performance computing (HPC) agent configured to determine one or more HPC environments for executing code according to workflows, a respective HPC environment of one or more HPC environments satisfying computing resource requirements of the set of code;
executing, by a computing agent configured to execute the code in the one or more HPC environments, the set of code within the respective HPC environment to generate an output associated with solving the computational problem,
wherein the HPC agent controls execution of the set of code by the computing agent according to the workflow;
applying, by the one or more processors, the supervisor model to the output to generate a solution to the computational problem; and
providing, by the one or more processors to the computing device, the solution.

18. The method of claim 17, further comprising:
determining, by the one or more processors, a domain associated with the computational problem; and
selecting, by the one or more processors, based upon the domain, a domain-specific model of a plurality of domain-specific models trained using respective domain-specific training data to provide solutions to respective domain-specific computational problems, wherein the supervisor model includes the domain-specific model.

19. The method of claim 17, further comprising:
validating, by a validation agent configured to validate the output of the code, the code; and
performing, by the validation agent, a corrective action responsive to the output failing validation.

20. A tangible machine-readable medium comprising instructions that, when executed by one or more processors, cause a machine to at least:
receive from a computing device, a request indicating a computational problem;
apply a supervisor model trained using model training data to the computational problem to generate (i) a workflow and (ii) a set of code;
determine, by a high-performance computing (HPC) agent configured to determine one or more HPC environments for executing code according to workflows, a respective HPC environment of one or more HPC environments satisfying computing resource requirements of the set of code;
execute, by a computing agent configured to execute the code in the one or more HPC environments, the set of code within the respective HPC environment to generate an output associated with solving the computational problem,
wherein the HPC agent controls execution of the set of code by the computing agent according to the workflow;
apply, by the one or more processors, the supervisor model to the output to generate a solution to the computational problem; and
provide, by the one or more processors to the computing device, the solution.
